(19) United States
(12) Patent Application Publication
(10) Pub. No.: US 2026/0014803 A1
(43) Pub. Date: Jan. 15, 2026

(54) PRINTING APPARATUS, CONTROL METHOD, AND STORAGE MEDIUM

(71) Applicant: CANON KABUSHIKI KAISHA, Tokyo (JP)

(72) Inventors: SERENA SAITO, Kanagawa (JP); KEIJI KURIYAMA, Saitama (JP)

(21) Appl. No.: 19/227,850

(22) Filed: Jun. 4, 2025

(30) Foreign Application Priority Data
Jul. 11, 2024 (JP) 2024-111909

(51) Int. Cl. B41J 2/21; B41J 3/46; B41J 11/00; G01N 21/31; G06K 15/02

(52) U.S. Cl. CPC B41J 2/2135; B41J 2/2117; B41J 2/2139; B41J 3/46; B41J 11/0095; G01N 21/31; G06K 15/027; G06K 15/1894; G06K 2215/0094; G06K 2215/101

(57) ABSTRACT

A printing apparatus includes a print head to eject first and second inks; a control unit to cause the print head to print adjustment patterns on a print medium, the adjustment patterns each including a first pattern printed with the first ink and a second pattern printed over the first pattern with the second ink and being different in optical density depending on a shift amount between the first and second patterns; an optical sensor to measure an optical characteristic of each adjustment pattern, wherein the first ink has an absorption wavelength range detectable with a required S/N ratio in a wavelength band detectable by the optical sensor, but the second ink does not have it; and a determination unit to determine a correction value for ejection timing of the second ink relative to the first ink based on the adjustment patterns printed by the print head.

### FIELD

The present disclosure relates to a printing apparatus, a control method, and a storage medium, and specifically relates to a technique for aligning the landing positions of ink droplets in an inkjet printer.

### DESCRIPTION OF THE RELATED ART

Japanese Patent Laid-Open No. H10-329381 discloses a technique in an inkjet printing apparatus for aligning the landing positions of ink droplets between reciprocating scans of a print head and for aligning the landing positions of ink droplets between multiple print heads. Specifically, this technique involves processing of causing the print head to form multiple patterns, measuring the optical characteristics of each of the multiple patterns, and determining the appropriate ejection timing in order to align the landing positions between two prints (first print and second print) to be aligned. This processing is called “registration adjustment (processing)”. The multiple patterns used in the registration adjustment are patterns formed in the first print and the second print, are formed respectively according to multiple shift amounts by each of which the landing positions in the first print and the second print are shifted from each other, and exhibit respective optical characteristics depending on the multiple shift amounts.

In addition, Japanese Patent Laid-Open No. 2016-221834 discloses a technique related to registration adjustment for a transparent liquid, optical characteristics of which are difficult to measure. Specifically, the disclosed technique is for the registration adjustment of the transparent liquid based on information on differences in smoothness among multiple patterns formed.

### SUMMARY

Japanese Patent Laid-Open No. H10-329381 uses an optical sensor as an optical characteristic measurement means to measure the optical characteristics of each of the multiple patterns. In the measurement of the optical characteristics, the optical density is detected from the luminescence of reflected light obtained after the inks absorb light emitted from a light emission unit of the optical sensor. Accordingly, in a case where a color ink whose optical density is undetectable is used, the registration adjustment may not be made correctly.

In Japanese Patent Laid-Open No. 2016-221834, the accuracy of the registration adjustment may decrease in a case where the multiple patters have equal smoothness.

Therefore, in view of the foregoing problems, the present disclose has an object to achieve accurate registration adjustment of an ink whose optical density is undetectable by an optical sensor.

An embodiment of the present disclosure is a printing apparatus including a print head configured to eject a first ink and a second ink; a control unit configured to control the print head so that the print head prints a plurality of adjustment patterns on a print medium, the adjustment patterns including a first pattern to be printed with the first ink and a second pattern to be printed on top of the first pattern with the second ink, wherein the plurality of adjustment patterns are different in optical density depending on a shift amount by which print positions of the first pattern and the second pattern are shifted from each other; an optical sensor configured to measure an optical characteristic of each of the plurality of adjustment patterns, wherein the first ink has an absorption wavelength range detectable with a required S/N ratio in a wavelength band detectable by the optical sensor and the second ink does not have the absorption wavelength range; and a determination unit configured to determine a correction value for ejection timing of the second ink relative to the first ink based on the plurality of adjustment patterns printed by the print head.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are perspective views of a printing apparatus;

FIGS. 2A and 2B are cross-sectional views illustrating a schematic structure of main components in the printing apparatus;

FIG. 3 is a schematic view illustrating a nozzle surface of a print head;

FIGS. 4A and 4B are schematic views of an optical sensor;

FIG. 5 is a block diagram illustrating a configuration of a control system of the printing apparatus;

FIGS. 6A to 6C are diagrams for explaining registration adjustment patterns in a first embodiment;

FIG. 7 is a flowchart of registration adjustment processing in the first embodiment;

FIG. 8 is a flowchart of manual registration adjustment processing in a second embodiment; and

FIGS. 9A to 9C are schematic views presenting GUIs for setting a registration adjustment value.

### DESCRIPTION OF THE EMBODIMENTS

Hereinafter, embodiments of the present disclosure will be described in detail in reference to the accompanying drawings. The following embodiments are not intended to limit the present disclosure more than necessary. In addition, all the combinations of features described in the embodiments are not necessarily essential for the solution of the present disclosure. The relative positions, shapes, and so on of components described in the embodiments are just examples and are not intended to limit the scope of the present disclosure only to these.

Hereinafter, a printing apparatus using an inkjet printing method will be described as an example. The printing apparatus may be a single function printer having only a printing function or a multifunction printer having multiple functions such as a printing function, a fax function, and a scanning function. Instead, the printing apparatus may be a manufacturing apparatus for manufacturing color filters, electronic devices, optical devices, micro structures, or the like by a certain printing method.

Here, “printing” means to form not only meaningful information such as characters and graphics, but also meaningless information. Moreover, “printing” broadly means to form an image, a design, a pattern, a structure, or the like on a print medium regardless of whether or not the formed product is so noticeable that humans can perceive it visually, and also means to process a medium. “Print media” include not only usual paper sheets for use in general printing apparatuses, but also any media capable of receiving inks, such as cloth, plastic film, metallic plate, glass, ceramic, resin, wood, or leather.

### First Embodiment

### <Basic Structure of Printing Apparatus>

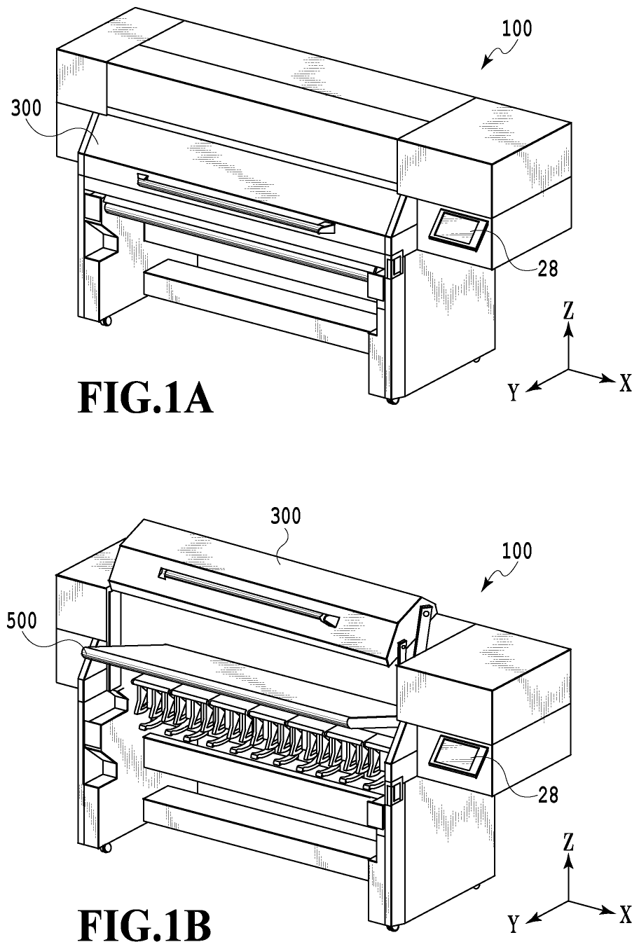

FIGS. 1A and 1B are views illustrating a basic structure of an inkjet printing apparatus (hereinafter referred to as the printing apparatus) 100 in the present embodiment.

FIG. 1A is the view illustrating a state where a fixing unit 300 and a paper delivery guide unit 600 to be described later are set in print positions (also referred to as the home positions). The state of the printing apparatus 100 in which the fixing unit 300 and the paper delivery guide unit 600 are set in the print positions as illustrated in FIG. 1A is referred to as a printing state.

FIG. 1B is the view illustrating a state where the fixing unit 300 and the paper delivery guide unit 600 are lifted up to retracted positions. The state of the printing apparatus 100 in which the fixing unit 300 and the paper delivery guide unit 600 are set in the retracted positions as illustrated in FIG. 1B is referred to as a non-printing state.

A user can input various settings to the printing apparatus 100 by using an operation panel 28 (such as various switches provided to the operation panel 28 in the present embodiment), the settings including a designation of a print medium size, a setting of a roll type, and so on.

In the present specification, directions in a view facing a side to which print media after printing are delivered are defined as follows: an X direction is a direction from the left side to the right side of the printing apparatus; a Y direction is a direction from the back side (rear side) to the front side of the printing apparatus, and a Z direction is a direction from the bottom side to the top side of the printing apparatus. Accordingly, the X direction, the Y direction, and the Z direction are each a direction from one side to the opposite side, and are orthogonal to each other. In the present specification, each direction is expressed, as needed, with “+ (plus sign)” in the case where the direction is from one side to the opposite side, and with “− (minus sign)” in the case where the direction is from the opposite side to the one side.

### <Structure of Main Components of Printing Apparatus>

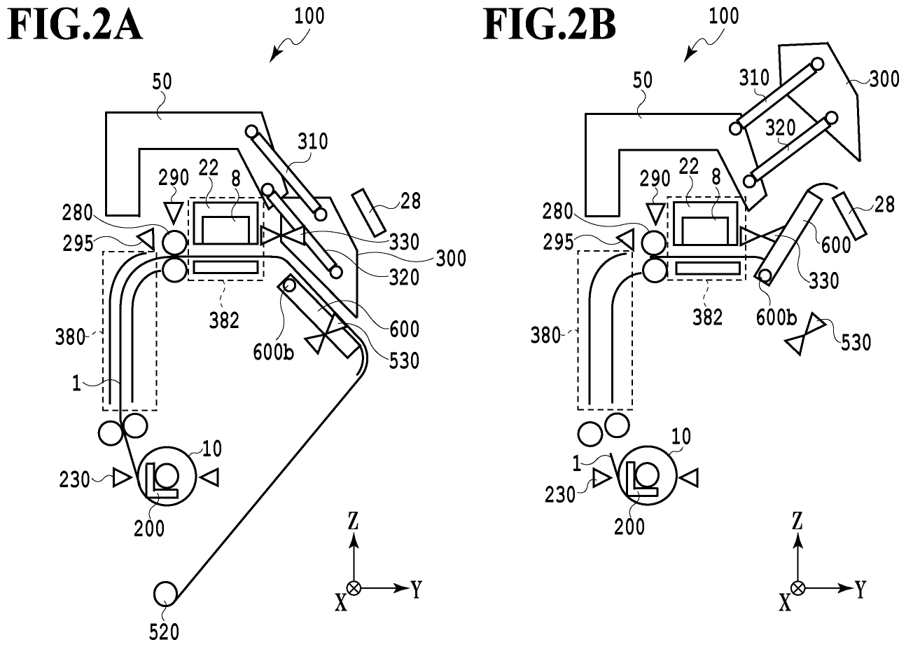

FIGS. 2A and 2B are cross-sectional views illustrating a schematic structure of main components in the printing apparatus 100.

FIG. 2A is the view in which both the fixing unit and the paper delivery guide unit are set in the print positions. FIG. 2B is the view in which both the fixing unit and the paper delivery guide unit are set in the retracted positions. In FIG. 2A, the printing apparatus 100 includes a paper feeder unit 200 to feed a print medium 1 from a print medium roll 10 in which the print medium 1 is rolled, and a printer unit 382 to print an image on the print medium 1. In addition, the printing apparatus 100 includes a winder unit 520 to wind the print medium after printing by the printer unit 382.

The printing apparatus 100 is set to the state where the fixing unit 300 and the paper delivery guide unit 600 are opened as illustrated in FIG. 2B in order to set the print medium roll 10, and then the print medium roll 10 is set in the printing apparatus 100 in that state. As will be described later, in the state where both the fixing unit 300 and the paper delivery guide unit 600 are in the upper retracted positions, a field of vision and a working area for a user are sufficiently provided and the user can easily set the print medium roll 10. In addition, during conveyance of the print medium 1 to the paper delivery guide unit 600, the fixing unit 300 is always retracted to the upper retracted position. For this reason, the print medium 1 is inhibited from hitting against the fixing unit 300 and thereby causing a paper jam.

As illustrated in FIG. 2A, in the case where the paper delivery guide unit 600 is closed, the print medium 1 drawn from the print medium roll 10 set in the paper feeder unit 200 is conveyed through a conveyor unit 380 to the printer unit 382, and an image is printed on the print medium 1 by the printer unit 382. The print medium 1 after printing is delivered toward the paper delivery guide unit 600 and dried for fixation in the fixing unit 300. With a winder roll set in a winder unit 520, the print medium 1 delivered can be wound in a roll form.

More specifically, the print medium 1 drawn from the print medium roll 10 set in the paper feeder unit 200 is conveyed through the conveyor unit 380 to the printer unit 382 capable of printing an image. The printer unit 382 prints an image on the print medium 1 by ejecting inks from a print head 8. The print head 8 ejects the inks from nozzles by using ejection energy generation elements such as electrothermal transducer elements (heaters) or piezo elements. In the case where the electrothermal transducer elements are used, the print head 8 can cause the inks to bubble by using heat generated by the transducer elements and eject the inks from the nozzles by using the resulting bubbling energy.

Here, the printing method of the print head 8 and the printer unit 382 is not limited only to the inkjet method. A method of driving the print head 8 may be a serial-scan method, a full-line method, or the like. In the case of the serial-scan method, an image is printed in a scan region of the print head 8 through operations of conveying the print medium 1 and scans of the print head 8 in a direction crossing a conveyance direction of the print medium 1. In the case of the full-line method, a long print head 8 extending in the direction crossing the conveyance direction of the print medium 1 is used and an image is printed on the print medium 1 while the print medium 1 is continuously conveyed.

The print medium 1 after printing is subjected to the ink fixation by drying in the fixing unit 300. As the fixing unit 300, for example, a unit that blows hot air to dry is known. The print medium 1 after the ink fixation by drying is wound in the roll form by a winder device in which the winder unit 520 is installed.

### <Movement Mechanism of Fixing Unit and Paper Delivery Guide Unit>

Hereinafter, a movement mechanism of the fixing unit 300 and the paper delivery guide unit 600 will be described by using FIGS. 2A and 2B.

In FIG. 2A, the fixing unit 300 dries the printed inks by blowing hot air to the print medium 1. The paper delivery guide unit 600 has a support surface to support the print medium 1 from below and guide the conveyance of the print medium 1. The paper delivery guide unit 600 is supported by paper delivery guide shafts 600b in a manner rotatable relative to an apparatus main body 50. Specifically, the paper delivery guide unit 600 is rotated counterclockwise from the state illustrated in FIG. 2A to the state illustrated in FIG. 2B. The paper delivery guide unit 600 is arranged to face the fixing unit 300.

A first link 310 and a second link 320 which constitute a unit to move the fixing unit 300 have one ends rotatably supported by the apparatus main body 50 and the other ends rotatably supported by the fixing unit 300. These two links constitute a parallel link mechanism. The above link structures are arranged in the same manner on both end sides of the fixing unit 300 in a longitudinal direction (X direction). In other words, two links are provided on each side, and four links in total are provided on both sides.

### <Structure of Print Head>

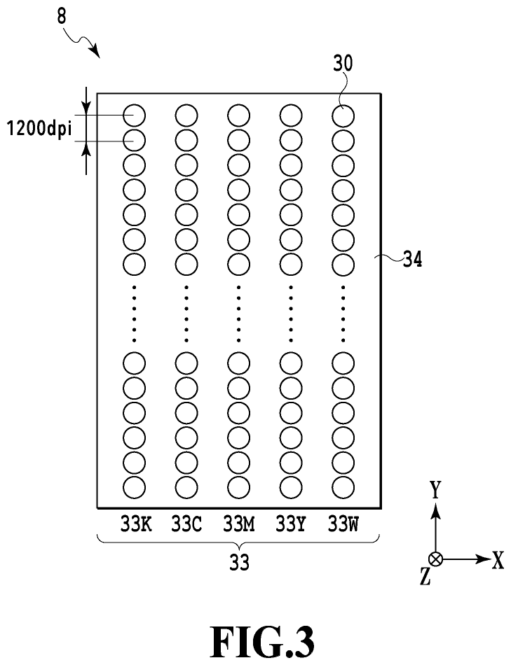

FIG. 3 illustrates a nozzle surface 34 of the print head 8 according to the present embodiment. The print head 8 includes a nozzle array 33K to eject a black ink, a nozzle array 33C to eject a cyan ink, a nozzle array 33M to eject a magenta ink, a nozzle array 33Y to eject a yellow ink, and a nozzle array 33W to eject a white ink. In the present specification, K denotes black, C denotes cyan, M denotes magenta, Y denotes yellow, and W denotes white.

In the print head 8, these nozzle arrays are arranged in the order of the nozzle arrays 33K, 33C, 33M, 33Y, and 33W from the left side to the right side in the X direction. Each of these nozzle arrays 33K, 33C, 33M, 33Y, and 33W is configured such that 1280nozzles 30 to eject the corresponding ink are arrayed in the Y direction (array direction) at a density of 1200 dpi. In the present embodiment, an ejection volume of the ink per ejection from each nozzle 30 is about 4.5 pl.

These nozzle arrays 33K, 33C, 33M, 33Y, and 33W are connected to respective ink tanks (not illustrated) that stores the inks dedicated to the nozzle arrays and are supplied with the inks. The print head 8 and the ink tanks used in the present embodiment may be configured as an integrated component or as separable components. Regarding the reference signs assigned to the nozzle arrays, the nozzle array will be simply expressed as the “nozzle array 33” in the case where there is no need to distinguish the nozzle array by color. The same rule regarding reference sings also applies to other components.

In each of the nozzles in the print head 8, an energy generation element (hereinafter also referred to as a printing element) is arranged which generates ejection energy for ejecting the ink from the nozzle. In the present embodiment, as this energy generation element, used is an electrothermal transducer which locally heats the ink to cause film boiling and ejects the ink by using the resulting pressure. However, the printing element is not limited to the electrothermal transducer and may be an electromechanical transducer.

### <Optical Sensor>

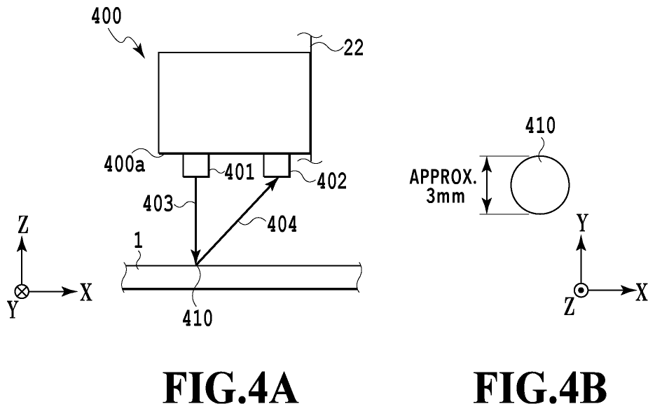

FIG. 4A is a schematic structural view of an optical sensor and FIG. 4B is a view illustrating a detection spot. An optical sensor 400 is fixedly attached to a carriage 22 so that its measurement region is located downstream of the multiple nozzle arrays 33 provided in the print head 8 in the +Y direction. A bottom surface 400a of the optical sensor 400 is flush with the nozzle surface 34 in the Z direction or is located in the +Z direction and downstream of the nozzle surface 34.

The optical sensor 400 includes a light emission unit 401 composed of a visible light LED of red, green, blue, or the like, and a light reception unit 402 composed of a photodiode. The optical sensor 400 has at least one light source color. The light emission unit 401 and the light reception unit 402 are provided on the bottom surface 400a of the optical sensor 400. The light emission unit 401 emits light to the print medium 1 and the light reception unit 402 receives the light reflected by the print medium 1. Accordingly, in the optical sensor 400, light 403 emitted from the light emission unit 401 is diffusely reflected by the print medium 1, and this reflected light 404 is received by the light reception unit 402. The spot diameter of a detection spot 410 in which the light 403 emitted from the light emission unit 401 is diffusely reflected by the print medium 1 is, for example, about 3 mm.

The light reception unit 402 transmits a detection signal, for example, an analog signal of the received reflected light 404 to a control circuit on an electric board of the printing apparatus 100 via a flexible cable (not illustrated) or the like. This analog signal is converted to a digital signal by an analog-to-digital converter (A/D converter) in the control circuit. For detection of optical characteristics of adjustment patterns to be described later, Y-direction conveyance of the print medium 1 and X-direction movement of the carriage 22 to which the optical sensor 400 is attached are alternately performed. This allows the optical sensor 400 to detect, as optical reflectance, an optical density of each image printed on the print medium 1 in synchronization with the timing based on a position signal obtained by an encoder (not illustrated).

A measurement error of the optical sensor 400 is determined based on a detection result obtained by printing multiple adjustment patterns each including the reference pattern and the shift pattern on the print medium 1 using a first ink and detecting the optical densities of the printed multiple adjustment patterns by the optical sensor 400. Specifically, an optical density difference between the highest optical density and the lowest optical density among the optical densities of the multiple adjustment patterns is greater than the measurement error of the optical sensor 400.

Similarly, a measurement error of the optical sensor 400 is determined based on a detection result obtained by printing the multiple adjustment patterns each including the reference pattern and the shift pattern on the print medium 1 using a second ink and detecting the optical densities of the printed multiple adjustment patterns by the optical sensor 400. Specifically, an optical density difference between the highest optical density and the lowest optical density among the optical densities of the multiple adjustment patterns is equal to or smaller than the measurement error of the optical sensor 400.

### <Configuration of Printing System>

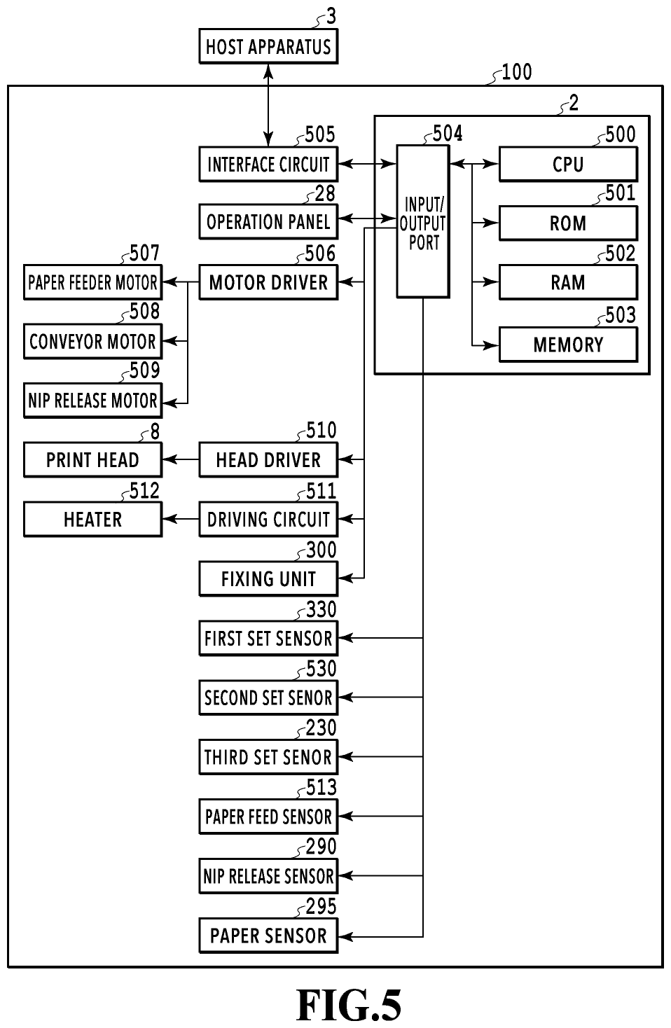

Hereinafter, a control system of the printing apparatus will be described by using FIG. 5. FIG. 5 is a block diagram illustrating a configuration of a control system of the printing apparatus.

A control unit 2 to control the entire printing apparatus 100 includes a central processing unit (CPU) 500, a ROM 501, a RAM 502, and a memory 503. The CPU 500 controls operations of all the constituent members and processes input image data in the printing apparatus 100 based on various programs. The ROM 501 functions as a memory to store various control programs and image processing programs to be executed by the CPU 500. The RAM 502 temporarily stores various data to be used to control the printing apparatus 100. The memory 503 stores various data such as mask patterns and adjustment patterns to be described later. The control unit 2 includes an input/output port 504. The control unit 2 is connected to an interface circuit 505 via the input/output port 504, and is connected to a host apparatus 3 via the interface circuit 505. In addition, via the input/output port 504, the control unit 2 is connected to the operation panel 28 that can be operated by a user, a motor driver 506, a head driver 510, a driving circuit 511, the fixing unit 300, various sensors, and so on.

The user inputs a job containing image data and print setting information to the printing apparatus 100 via the host apparatus 3, and inputs various kinds of information to the printing apparatus 100 via the host apparatus 3 and the operation panel 28. The control unit 2 is connected to the motor driver 506 via the input/output port 504, and controls driving of a paper feeder motor 507, a conveyor motor 508, and a nip release motor 509 via the motor driver 506. The paper feeder motor 507 is a driving source of the paper feeder unit 200 to feed the print medium 1. The conveyor motor 508 is a driving source of a conveyor unit such as a conveyor roller pair 280 to convey the print medium 1 fed from the paper feeder unit 200 to the printer unit 382. The nip release motor 509 is a driving source for a driving force to release a nip in the conveyor roller pair 280.

The control unit 2 is connected to the head driver 510 via the input/output port 504 and controls the print head 8 via the head driver 510 to cause the print head 8 to eject the inks. The control unit 2 also controls driving of heaters 512 in the print head 8 via the driving circuit 511.

In the control unit 2, the CPU 500 converts image data input from the host apparatus 3 to print data, and stores the print data into the RAM 502. Specifically, the CPU 500 obtains image data in a bitmap format expressed by 8-bit, 256-ary value information (0 to 255) for each color in RGB, and converts this image data into multi-valued data expressed with K, C, M, Y, and W to be used for printing. This color conversion processing generates multi-valued data expressed by 8-bit, 256-ary value information (0 to 255) that defines a gray level of each of the inks K, C, M, Y, and W in each pixel of a pixel group including multiple pixels.

Next, the multi-valued data expressed with K, C, M, Y, and W is quantized to generate quantized data (binary data) expressed by 1-bit binary information (1, 0) that determines whether or not to eject each of the inks K, C, M, Y, and W for each pixel. Here, 1 specifies ejection and 0 specifies non-ejection. For this quantization processing, any of various known quantization methods may be used such as an error diffusion method, a dither method, and an index method. After that, allocation processing is performed for allocating the quantized data to multiple scans by the print head 8 per unit region. This allocation processing generates print data represented by 1-bit binary information (1, 0) that determines whether or not to eject each of the inks K, C, M, Y, and W to each pixel in each of the multiple scans for each unit region of the print medium 1. This allocation processing is executed by using mask patterns that are respectively applied to the multiple scans and determine whether or not to permit ink ejection for each pixel. The generation of the print data as described above does not have to be entirely executed by the control unit 2. The generation processing may be executed by the host apparatus 3. Instead, part of the generation processing may be executed by the host apparatus 3 and the remaining part of the processing may be executed by the control unit 2.

In addition, the printing apparatus 100 is provided with a first set sensor 330 to detect that the fixing unit 300 is set in the print position. Similarly, the printing apparatus 100 is provided with a second set senor 530 to detect that the paper delivery guide unit 600 is set in the print position. Furthermore, the printing apparatus 100 is provided with a third set senor 230 to detect that the print medium roll 10 is set in the printing apparatus 100.

Moreover, the printing apparatus 100 is provided with a paper feed sensor 513 to detect the feeding of the print medium 1, a nip release sensor 290 to detect a release of the nip in the conveyor roller pair 280, and a paper sensor 295 to detect an edge of the print medium 1. The nip release sensor 290 is, for example, a photosensor, and includes a light emission unit and a light reception unit. The nip release sensor 290 detects an interruption of light reception upon release of the nip and thereby detects the release of the nip in the conveyor roller pair 280.

### <Inks>

Next, the inks K, C, M, Y, and W used in the present embodiment will be described. Each of these inks contains a solid component for printing images and a volatile liquid component. The solid component includes a colorant such as a pigment or dye, whereas the liquid component includes water and a water-soluble organic solvent. All the inks contain water-soluble resin fine particles for improving rubfastness (fixation) of printed images by firmly sticking the colorants to the print medium 1. In addition, in order to impart desired properties as needed, various agents may be added as appropriate such as a surfactant, a defoamer, a preservative, and an antifungal agent.

The color inks (K, C, M, Y) in the present embodiment contain water-soluble resin fine particles for improving rubfastness (fixation) of printed images by firmly sticking the colorant to the print medium 1. The resin fine particles melt with heating, and a heater (such as the fixing unit 300) forms a film of the resin fine particles and dries the solvent contained in the ink. In the present embodiment, the resin fine particles are polymer fine particles existing in a dispersed state in water. The polymer fine particles existing in the dispersed state in water may be in the form of resin fine particles obtained by homopolymerizing or copolymerizing one or multiple types of monomers having dissociable groups, that is, a so-called self-dispersing resin fine particle dispersion.

Each of the color inks contains a surfactant. As the surfactant, a penetrant to improve the penetration power of the color ink into the print medium 1 dedicated for inkjet printing is used. In the present embodiment, the inks are adjusted such that the surface tension of each color ink is 30 dyn/cm or less and the difference in surface tension among the color inks is 2 dyn/cm or less. Specifically, the surface tensions of the color inks are adjusted to about 28 to 30 dyn/cm.

In addition, each of the color inks preferably has a pH of 7.0 or more and 10.0 or less in order to prevent elution of impurities from the members that come into contact with the ink in the printing apparatus 100 and the print head 8, deterioration of materials constituting the members, and a decrease in the solubility of a pigment dispersion resin in the ink. The color inks used in the present embodiment use anionic colorants. For this reason, the pH of each of the color inks is stable on an alkali side with its value in a range from 8.5 to 9.5.

The white ink in the present embodiment contains a white colorant as the colorant. As the white colorant of the white ink, titanium oxide particles may be suitably used. Titanium oxides are classified into rutile, anatase, and brookite types based on their crystal structures. Among them, the rutile type of titanium oxide having low photocatalytic activity is preferred. Methods for producing titanium oxide include a sulfuric acid method, a chlorine method, and the like. The content (% by mass) of the titanium oxide in the ink based on the total mass of the ink is preferably 5% by mass or more and 20% by mass or less from the viewpoint of the stability of the ink.

The zeta potential of the titanium oxide particles in pure water is preferably 0 mV or more. The zeta potential is an index that indicates a charged state of the surfaces of titanium oxide particles, and can be measured by an electrophoretic light scattering method. In a case of the surfaces of the titanium oxide particles in which the positive charge is predominant over the negative charge, the titanium oxide particles tend to adsorb to a resin having anionic groups, thereby improving the dispersion stability of the titanium oxide. In addition, the zeta potential is preferably 40 mV or less in order to prevent an excessive consumption of the anionic groups of the resin from resulting in a shortage of charge repulsion between the titanium oxide particles.

In addition to the titanium oxide particles, resin particles having a hollow structure may also be used in combination as the white colorant of the white ink. As such resin particles, there are resin particles containing units derived from styrene and acrylic, such as MH5055 (manufactured by Zeon Corporation), Ropaque OP-62, OP-84J, OP-91, HP-1055, HP-91, and ULTRA (all manufactured by Rohm and Haas Company). In addition, there are resin particles containing units derived from crosslinked styrene and acrylic, such as SX-863 (A), 864 (B), 866 (A), 866 (B), and 868 (all manufactured by JSR Corporation), Ropaque ULTRA E and ULTRA DUAL (both manufactured by Rohm and Haas Company), and the like.

The white ink contains the above-mentioned white colorant as a main ingredient, and may additionally contain another colorant to adjust the white tone that is slightly visually recognizable due to reflected light or the like, as long as the whiteness is not impaired.

Next, a fluorescent ink used in the present embodiment will be described. In the present embodiment, a fluorescent ink is used which is made by mixing a dispersion having fluorescent properties, a solvent, and an activator. The fluorescent dispersion used in the present embodiment is a dispersion having fluorescent properties. For example, NKW-3207E (fluorescent pink water dispersion: Japan Fluorescent Chemical Co., Ltd.), NKW-3205E (fluorescent yellow water dispersion: Japan Fluorescent Chemical Co., Ltd.), or the like may be used, but any dispersion having fluorescent properties may be used.

The above fluorescent dispersion is mixed with and dispersed in a known solvent and an activator to produce an ink. A method of dispersing the fluorescent dispersion is not particularly limited. For example, a fluorescent dispersion dispersed with a surfactant, a resin-dispersing fluorescent dispersion dispersed with a dispersing resin, or the like may be used. Of course, fluorescent dispersions with different dispersion methods may be used in combination. As the surfactant, an anionic surfactant, a nonionic surfactant, a cationic surfactant, or a zwitterionic surfactant may be used. As the dispersing resin, any water-soluble or water-dispersible resin may be used, but a dispersing resin having a weight-average molecular weight of 1,000 or more and 100,000 or less, and more preferably 3,000 or more and 50,000 or less is particularly preferred. As the solvent, an aqueous medium containing, for example, water and a water-soluble organic solvent is preferably used.

### <Print Media>

The printing apparatus in the present embodiment performs printing on low-permeability print media that are difficult for moisture to penetrate. A low-permeability print medium mentioned herein is a medium that has no water absorbency or absorbs only a very small amount of water as described above. For this reason, in the case where an aqueous ink containing no organic solvent is used, it is impossible to print an image because the aqueous ink is repelled. On the other hand, the low-permeability print media are excellent in water resistance and weather resistance and therefore are suitable as media for forming printed products intended for outdoor usage. In general, print media having a water contact angle of 45° or more and preferably 60° or more at 25° C. are used.

The low-permeability print media include print media each coated with plastic, or more specifically having a plastic layer formed on the top surface of a base material, print media each having no ink-receptive layer formed on a base material, and sheets, films, banners, and the like made of glass, Yupo, plastic, and the like. Examples of the plastic for coating include polyvinyl chloride, polyethylene terephthalate, polycarbonate, polystyrene, polyurethane, polyethylene, polypropylene, and the like. These low-permeability print media are excellent in water resistance, light resistance, and scratch resistance and therefore are generally used for printing of print products intended for outdoor exhibition.

As an example of a method for evaluating the permeability of a print medium, the Bristow method described in JAPAN TAPPI, Paper and Pulp Test Method No. 51, “Method for determining liquid absorbency of paper and paperboard” can be used. The Bristow measurement method will be briefly described below. A predetermined amount of ink is first poured into a holding container with an opening slit in a predetermined size, and then the ink is brought into contact with a print medium, which is cut in a strip shape and wound around a wheel in advance, through the slit. Then, the wheel is rotated while the position of the holding container is kept fixed, and the area (length) of an ink band transferred to the print medium is measured. The ink transfer amount per unit area per second (ml·m−2) can be calculated from the area of this ink band. In the present embodiment, a print medium in which an ink transfer amount (water absorption amount) at 30 msec ½ according to the Bristow method is less than 10 ml·m−2 is regarded as a low-permeability print medium.

### <Specific Adjustment Method>

First, the adjustment patterns used in the present embodiment will be described. It should be noted that the adjustment patterns described below are just one example of adjustment patterns to which the present embodiment is applicable, and different adjustment patterns may be set as appropriate with other factors taken into consideration.

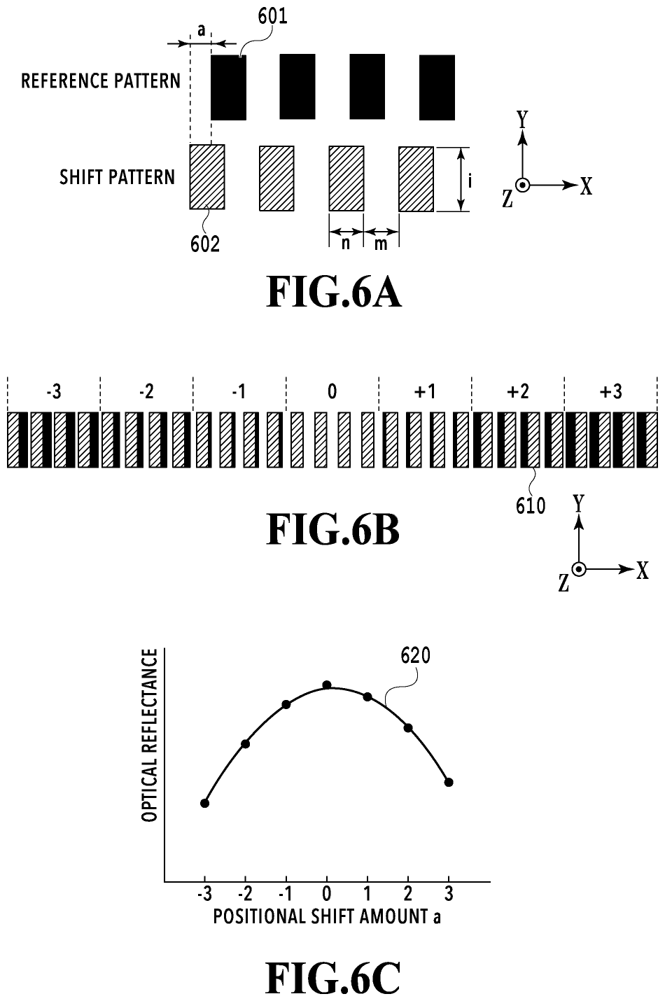

FIG. 6A is a diagram for explaining a configuration example of a registration adjustment pattern to be used to detect the optical density by the optical sensor 400 in the present embodiment.

As illustrated in FIG. 6A, the registration adjustment pattern is configured in which rectangular patterns of i×n pixels are arranged in a main scanning direction repeatedly cyclically while interposing each blank region of m pixels in between. A shift pattern 602 is printed at a print position shifted by a predetermined number a of pixels from a reference pattern 601. The print resolution and the shift amount for printing these registration adjustment patterns may be determined depending on the print resolution of the printing apparatus 100. In the present embodiment, the print resolution for printing the registration adjustment patterns is 1200 dpi. Although FIG. 6A presents the reference pattern and the shift pattern displaced in the vertical direction for convenience of description, these two patterns (the reference pattern 601 and the shift pattern 602) are actually printed one on top of the other (see FIG. 6B). More specifically, the reference pattern is printed so as to overlap the shift pattern shifted in the main scanning direction by the predetermined number a of pixels. In this printing, the reference pattern is first printed and then the shift pattern is printed over the printed reference pattern. A time for drying the printed pattern (referred to as the drying time) may be provided between the printing of the reference pattern and the printing of the shift pattern. With the drying time provided, it is possible to further reduce a decrease in density due to color mixing of the inks. The drying time may be changed depending on properties of an ink for printing the reference pattern 601 (referred to as the first ink: the ink K in the present example), properties of an ink for printing the shift pattern (referred to as the second ink: the ink W in the present example), or properties of the print medium 1.

The nozzle arrays to be used to print the reference pattern and the shift pattern are determined by a combination of ink colors of the nozzle arrays to be adjusted. For example, a nozzle array of an ink having an absorption wavelength band (also called an absorption wavelength range) detectable with a required S/N ratio in a wavelength band (visible light range) detectable by the optical sensor 400 (for example, the nozzle array 33K) is determined as a reference nozzle array, and the reference pattern is printed by using this reference nozzle array. After that, the shift pattern is printed by using a nozzle array of an ink not having an absorption wavelength band detectable with a required S/N ratio in the wavelength band (visible light range) detectable by the optical sensor 400 (for example, the nozzle array 33W of the ink W). However, the combination of the nozzle arrays is not limited to the above. The nozzle arrays may be combined as appropriate. As the ink not having an absorption wavelength band detectable with a required S/N ratio in the wavelength band (visible light range) detectable by the optical sensor 400, it is also possible to select a fluorescent ink or an ink having an ink color whose optical density is difficult to detect because the ink does not absorb the wavelength of light emitted from the light emission unit. Such ink is the magenta ink in the case where the light source color of the light emission unit is red.

An example of the ink whose optical density is difficult to detect is the white ink that does not absorb the light emitted from the light emission unit. Another example is a color ink whose optical density is difficult to detect because the ink does not absorb the light emitted from the light emission unit, as similar to the magenta ink in the case where the light source color of the light emission unit is red. Still another example is a fluorescent ink that absorbs the light emitted from the light emission unit and simultaneously emits light.

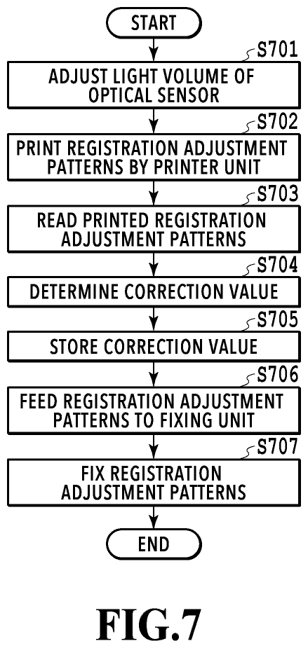

FIG. 6B illustrates a configuration in which multiple registration adjustment patterns illustrated in FIG. 6A are arranged in the main scanning direction. In this case, a registration adjustment pattern group 610 illustrated in FIG. 6B is printed with the shift amount of the shift pattern changed stepwise from −3 pixels to +3 pixels. As can be seen from FIG. 6B, in the case of the shift amount of 0, the reference pattern and the shift pattern are printed in an exactly superimposed manner. As the shift amount increases, the misalignment the reference pattern and the shift pattern increases and accordingly the width of the reference pattern appearing on the print medium increases. For convenience, FIG. 6B illustrates the case where the misalignment the reference pattern and the shift pattern is small with the shift amount set to 0. However, in actual printing of the registration adjustment patterns, a position with a small misalignment the reference pattern and the shift pattern may vary depending on various conditions. As will be described in detail later, a correction value for the ejection timing for ejecting an ink not having a detectable absorption wavelength band as described above is calculated based on the value of the shift amount a applied to the position with the smallest misalignment (see S704 in FIG. 7).

As the shift amount between the print positions of the reference pattern and the shift pattern is changed, an area ratio of the ink of the reference pattern appearing on the print medium changes, as presented in FIG. 6B.

FIG. 6C presents (optical) reflectance measurement results 620 of the registration adjustment patterns in FIG. 6B measured by the optical sensor 400. Here, the optical density is inversely proportional to the reflectance. As the misalignment the reference and shift patterns in the registration adjustment pattern actually printed on the print medium becomes smaller, a larger area of the reference pattern printed with the ink whose density is detectable by the optical sensor 400 is hidden by the shift pattern printed with the ink whose density is undetectable by the optical sensor 400, and accordingly the optical density decreases. In other words, the higher the reflectance of the registration adjustment pattern, the smaller the misalignment the reference pattern and the shift pattern. For this reason, the value of the positional shift amount a in the registration adjustment pattern with the lowest optical density (with the highest reflectance) may be selectively determined as a registration adjustment value.

The number and shift amounts of registration adjustment patterns to be printed on a print medium may be determined according to an adjustment range required by the mechanical tolerance of the apparatus and a unit of shifting the print position. In short, the number and shift amount may be determined according to the accuracy in the registration adjustment. A print region on which the registration adjustment patterns are to be printed on a print medium may be determined depending on factors such as the size of a detection region of the optical sensor 400, the width of a region printable in one print scan, the size of the registration adjustment pattern group, and the size of the printable region of the print medium 1. For example, it is preferable that a registration adjustment pattern composed of the reference pattern and the shift pattern corresponding to each shift amount be larger than the spot diameter of the optical sensor 400. In FIG. 6B, each section bordered by dotted lines is equivalent to the width of one registration adjustment pattern in the X direction, and this width just has to be larger than the spot diameter of the optical sensor. This makes it possible to prevent the optical sensor from reading a paper-white portion of the print medium or adjacent registration adjustment patterns, resulting in more accurate detection of the optical density of each pattern. Each registration adjustment pattern may be printed with multiple scans by the print head 8. Specifically, the reference pattern is printed with multiple scans by the print head 8 without conveyance of the print medium 1, and then the shift pattern is printed with multiple scans by the print head 8 without conveyance of the print medium 1. Since a decrease in density due to color mixing of the inks can be reduced more as the number of scans during printing increases, the number of scans for printing the reference pattern and the number of scans for printing the shift pattern may each be increased as necessary. Furthermore, the number of scans for printing the reference pattern and the number of scans for printing the shift pattern may each be changed according to properties of the first ink, properties of the second ink, or properties of the print medium 1.

The correction value is determined based on the positional shift amount a determined in this way. The registration adjustment value is a value specifying an amount of correction of the ink ejection timing, and the ejection timing of an ink whose optical density is undetectable by the optical sensor 400 is controlled based on this correction value.

FIG. 7 is a flowchart of processing to be executed to make registration adjustment using a white print medium in the present embodiment (referred to as registration adjustment processing). This registration adjustment processing is, for example, processing executed by the CPU 500 loading a program stored in the ROM 501 to the RAM 502 and controlling the constituent members in accordance with the read program.

First in step S701, the CPU 500 adjusts a light volume of the optical sensor 400 by using a paper-white portion of a print medium 1. In the following description, “step S ###” will be abbreviated as “S ###” for simplification.

In S702, the CPU 500 prints the registration adjustment patterns as presented in FIGS. 6A and 6B by using the printer unit 382.

In S703, the CPU 500 reads the registration adjustment patterns printed in S702 by using the optical sensor 400.

In S704, the CPU 500 determines the correction value based on the a detection result of the reading in S703. Specifically, the CPU 500 determines, as the registration adjustment value, the value of the positional shift amount a with the lowest optical density (with the highest reflectance) from a predetermined range of positional shift amounts a (−3 to +3 in the present example), and calculates the correction value based on the determined registration adjustment value. Although the mode is described herein in which the correction value for the ejection timing of the second ink relative to the first ink is determined based on the positional shift amount a in the registration adjustment pattern with the lowest optical density, the present embodiment is not limited to this mode. Depending on a combination of a first ink and a second ink, the correction value for the ejection timing of the second ink relative to the first ink may be determined based on the positional shift amount a in the registration adjustment pattern with the highest optical density.

In S705, the CPU 500 stores the correction value calculated in S704 to the RAM 502. Thereafter, the registration adjustment of the ink whose optical density is undetectable by the optical sensor 400 (the white ink in the present example) is performed by using the correction value stored or set in this step.

In S706, the CPU 500 feeds the registration adjustment patterns to the fixing unit 300 so as not to cause stains of the inks used in the printing of the registration adjustment patterns.

In S707, the CPU 500 fixes the registration adjustment patterns on the print medium by using the fixing unit 300. After completion of this step, the registration adjustment processing is ended.

Although the present embodiment uses the nozzle array 33K as the reference nozzle array and the white print medium as the print medium different in color from the black ink ejected from the nozzle array 33K, the color of the print medium 1 is not limited to white. As the color of the print medium 1, any color different from the color of the ink ejected from the reference nozzle array may be used.

### Effects of Present Embodiment

According to the present embodiment, as described above, it is possible to control the ejection timing of an ink whose optical density is undetectable by an optical sensor, thereby achieving accurate registration adjustment of the ink.

### Second Embodiment

In the first embodiment, accurate registration adjustment for a color ink whose optical density is undetectable by an optical sensor can be made by using the optical sensor. However, registration adjustment using the registration adjustment patterns described in the first embodiment can be made without using an optical sensor. Therefore, in the following embodiment, a mode without using an optical sensor will be described. Hereinafter, differences from those in the first embodiment will be mainly explained, and explanations of contents common to the first embodiment will be omitted as appropriate.

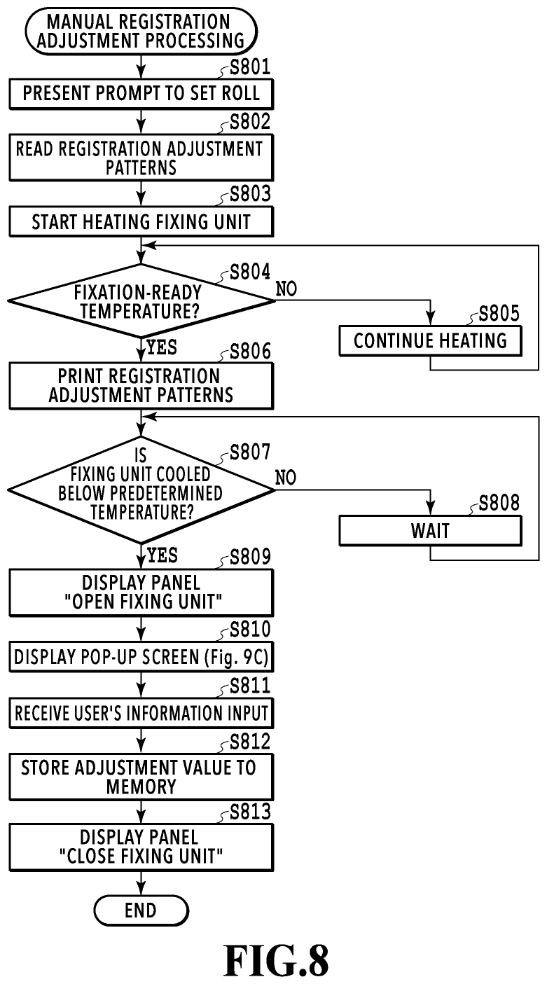

FIG. 8 is a flowchart of processing to be executed by a user to manually make registration adjustment by using a print medium in the present embodiment (referred to as manual registration adjustment processing). This manual registration adjustment processing is, for example, processing executed by the CPU 500 loading a program stored in the ROM 501 to the RAM 502 and controlling the constituent members in accordance with the read program. Hereinafter, description will be given of a procedure started in response to a user's selection of registration adjustment via the operation panel 28.

In response to a user's selection of execution of registration adjustment of the print head 8 via the operation panel 28, the CPU 500, first in S801, presents a prompt to cause the user to set a print medium roll 10 in the printing apparatus 100. In this step, the prompt may be presented by displaying a GUI or message on the operation panel 28 or outputting a voice. After seeing the prompt presented in this step, the user sets the print medium roll 10 in the printing apparatus 100.

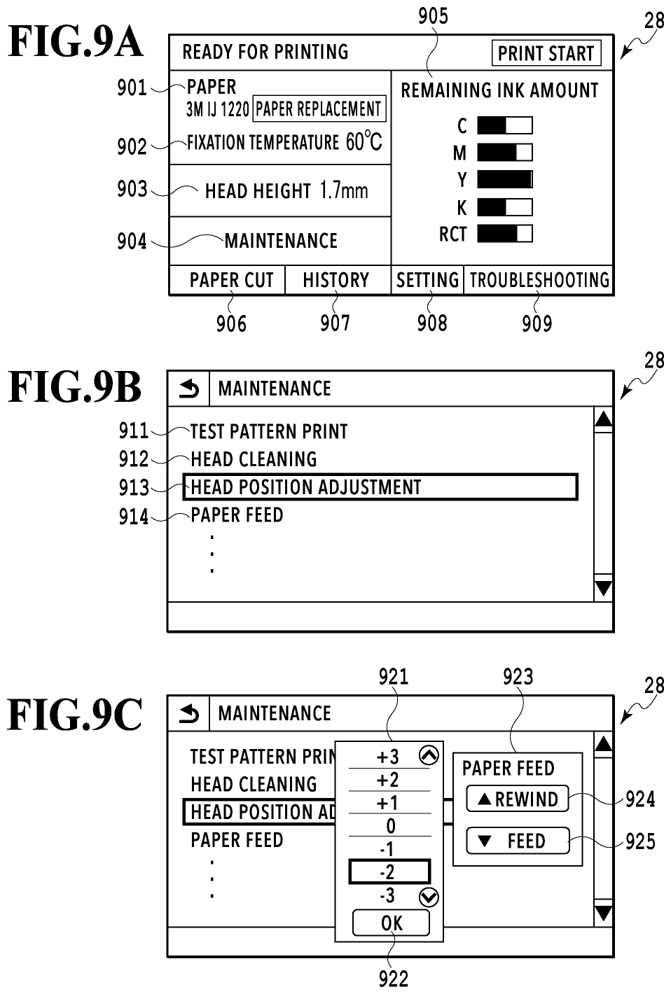

FIGS. 9A to 9C present specific examples of UI display (GUI screens) provided on the operation panel 28. Using various switches and others provided to the operation panel 28, the user is enabled to input various settings to the printing apparatus 100, such as specifying the size of a print medium and setting a roll type.

FIG. 9A presents a GUI screen displayed on the operation panel 28. This screen displays items such as “roll paper type” 901 set in the printing apparatus 100, “hot air temperature of fixing unit” 902, “print head height” 903, “maintenance” 904, and “remaining ink amount” 905. In addition, other items such as “paper cut” 906, “print history” 907, “other settings” 908, and “troubleshooting” 909 are displayed, the user is enabled to select any item among these items to transmit an instruction to the printing apparatus 100. The layout and various setting items on the GUI screen are presented in a simplified manner for the purpose of explanation, and an embodiment is not limited to these.

In the case where the user desires to make registration adjustment, the user selects (presses down) the “maintenance” 904 on the GUI screen presented in FIG. 9A. In response to this, the GUI screen displayed on the operation panel 28 is switched to a maintenance screen presented in FIG. 9B. This maintenance screen displays items such as “test pattern print” 911, “head cleaning” 912, “head position adjustment” 913, and “paper feed adjustment” 914.

In response to a user's selection (pressing down) of the “head position adjustment” 913 via the maintenance screen, the CPU 500 in S802 reads the registration adjustment patterns among various patterns stored in the memory 503.

In S803, the CPU 500 starts heating the fixing unit 300 to a predetermined fixation-ready temperature.

In S804, the CPU 500 determines whether or not the temperature of the fixing unit 300 reaches the fixation-ready temperature. In the case where the determination result in this step is true, the processing proceeds to S806. On the other hand, in the case where the determination result in this step is false, the processing proceeds to S805.

In S805, the CPU 500 continues heating the fixing unit 300.

In S806, the CPU 500 prints the registration adjustment patterns read from the memory 503 by using the printer unit 382. After completing the printing of the registration adjustment patterns in this step, the CPU 500 stops heating the fixing unit 300.

In S807, the CPU 500 determines whether or not the temperature of the fixing unit 300 decreases below a predetermined temperature. In the case where the determination result in this step is true, the processing proceeds to S808. On the other hand, in the case where the determination result in this step is false, the processing proceeds to S809.

In S808, the CPU 500 waits for a predetermined time. In this step, the temperature of the fixing unit 300 decreases.

In S809, the CPU 500 displays a message “Open Fixing Unit” on the operation panel 28 and thereby prompts the user to lift up the fixing unit 300. In the present embodiment, after the registration adjustment patterns are printed, the printed surface of the print medium is dried by the fixing unit 300. The main purpose of this is to prevent the printed surface on the output print medium from being stained with the inks due to user's touching. Although depending on a type of print medium actually used for printing, a certain type of print medium can be quickly ready for visual inspection of the shift amount a without drying by the fixing unit 300. Therefore, the fixing by the fixing unit 300 is not essential. For this reason, in order to cut down a wait time required to heat the fixing unit 300 to the fixation-ready temperature and cool the fixing unit 300, a method not involving drying by the fixing unit 300 may be employed. In other words, after the printing of the registration adjustment patterns (S806) as described above, the processing may skip execution of the processes in S807 and S808 and directly proceed to S809, where “Open Fixing Unit” is displayed on the operation panel 28 to prompt the user to lift up the fixing unit 300.

Upon detecting that the user opens the fixing unit 300, the CPU 500 in S810 displays a pop-up screen presented in FIG. 9C on the operation panel 28. FIG. 9C presents a screen displayed on the operation panel 28 upon detection of an action where the user lifts up the fixing unit 300 after seeing the message displayed in S809 after the execution of the printing of the registration adjustment patterns (S806) and presents the pop-up screen superimposed on the maintenance screen. As presented in FIG. 9C, the pop-up screen is composed of a first pop-up screen 921 on which a registration adjustment value can be selected from the range of +3 to −3 as the shift amount a, and a second pop-up screen 923. The second pop-up screen 923 has a “rewind” button 924 for rewinding the print medium 1 and a “feed” button 925 for feeding out the print medium 1 to the winding direction, and the user can select either “rewind” or “feed” by pressing one of these buttons.

After the end of the operation of printing the registration adjustment patterns, the user opens the fixing unit 300 and visually inspects the printed registration adjustment patterns. Then, in the same method as in the first embodiment (see FIG. 6B), the user selectively determines an appropriate registration adjustment value (a value in the range of −3 to +3) from the shift amounts a in the registration adjustment pattern group. In this step, the user can rewind the print medium by pressing down the “rewind” button, so that the registration adjustment patterns can be returned to a position on the support member at which it is easy for the user to visually inspect the patterns.

After visually inspecting the adjustment patterns and determining the appropriate shift amount a from the range of +3 to −3, the user inputs information on the appropriate adjustment value and then presses down a “OK” button 922 via the first pop-up screen 921. In this step, the user inputs the shift amount in the pattern closest to a state in which the reference pattern and the shift pattern are exactly aligned on the same position. In S811, the CPU 500 receives this information input by the user.

In S812, the CPU 500 stores the information on the registration adjustment value obtained in S811 to the memory 503. As in the first embodiment, the correction value for the ejection timing of the ink W relative to the ink K is determined based on the registration adjustment value stored in this step.

In S813, the CPU 500 displays a message “Lift Down Fixing Unit” on the operation panel 28. After seeing this message, the user returns the fixing unit 300 to the print position. Upon detecting that the fixing unit 300 is set in the print position, the CPU 500 ends the manual registration adjustment processing. After that, the ink ejection timing in each of the nozzle arrays is controlled based on the adjustment value stored or set in the manual registration adjustment processing.

The above description presents the configuration in which the user lifts up the fixing unit 300 and visually inspects the adjustment patterns, but a configuration of the printing apparatus 100 to which the present embodiment is applicable to is not limited to this. For example, in a case where the fixing unit 300 is transparent, there is no need to lift up and down the fixing unit 300.

### Effects of Present Embodiment

According to the present embodiment, even in the case where a printing apparatus is not equipped with an optical sensor, it is possible to perform the registration adjustment using the adjustment patterns described in the first embodiment by causing a user to input a result of visual inspection as described above.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

According to the present disclosure, the registration adjustment of a color ink whose optical density is undetectable by an optical sensor can be performed with high accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-111909, filed Jul. 11, 2024, which is hereby incorporated by reference wherein in its entirety.

1. A printing apparatus comprising:
a print head configured to eject a first ink and a second ink;
a control unit configured to control the print head so that the print head prints a plurality of adjustment patterns on a print medium, the adjustment patterns each including a first pattern to be printed with the first ink and a second pattern to be printed on top of the first pattern with the second ink, wherein the plurality of adjustment patterns are different in optical density depending on a shift amount by which print positions of the first pattern and the second pattern are shifted from each other;
an optical sensor configured to measure an optical characteristic of each of the plurality of adjustment patterns, wherein the first ink has an absorption wavelength range detectable with a required S/N ratio in a wavelength band detectable by the optical sensor and the second ink does not have the absorption wavelength range; and
a determination unit configured to determine a correction value for ejection timing of the second ink relative to the first ink based on the plurality of adjustment patterns printed by the print head.

2. The printing apparatus according to claim 1, further comprising a conveyor unit configured to convey the print medium in a conveyance direction.

3. The printing apparatus according to claim 2, wherein the determination unit determines the correction value based on a detection result on the plurality of adjustment patterns obtained by the optical sensor.

4. The printing apparatus according to claim 3, wherein
the detection result is an optical density of each of the plurality of adjustment patterns, and
the determination unit determines the correction value based on the shift amount in the adjustment pattern with the highest or lowest optical density among a plurality of optical densities respectively detected on the plurality of adjustment patterns.

5. The printing apparatus according to claim 2, further comprising an operation unit configured to present information to a user and allow the user to input information, wherein
the determination unit determines the correction value based on an input by the user via the operation unit.

6. The printing apparatus according to claim 3, wherein the first pattern is first printed and then the second pattern is printed after a predetermined drying time.

7. The printing apparatus according to claim 6, wherein the predetermined drying time is changed depending on a property of the first ink, a property of the second ink, or a property of the print medium.

8. The printing apparatus according to claim 7, wherein the number of scans for printing the first pattern and the number of scans for printing the second pattern are each increased.

9. The printing apparatus according to claim 8, wherein the number of scans for printing the first pattern and the number of scans for printing the second pattern are each changed depending on a property of the first ink, a property of the second ink, or a property of the print medium.

10. The printing apparatus according to claim 9, wherein a length of the first pattern in a direction orthogonal to the conveyance direction and a length of the second pattern in the direction orthogonal to the conveyance direction are larger than a spot diameter of the optical sensor.

11. The printing apparatus according to claim 9, wherein a length of the first pattern in the conveyance direction and a length of the second pattern in the conveyance direction are larger than a spot diameter of the optical sensor.

12. The printing apparatus according to claim 10, wherein
a measurement error of the optical sensor is determined based on a detection result obtained by printing a plurality of adjustment patterns, each including the first pattern and the second pattern, with the first ink on a print medium, and detecting optical densities of the plurality of adjustment patterns by the optical sensor, and
an optical density difference between the highest optical density and the lowest optical density among the optical densities of the plurality of adjustment patterns is greater than the measurement error.

13. The printing apparatus according to claim 11, wherein
a measurement error of the optical sensor is determined based on a detection result obtained by printing a plurality of adjustment patterns, each including the first pattern and the second pattern, with the second ink on a print medium, and detecting optical densities of the plurality of adjustment patterns by the optical sensor, and
an optical density difference between the highest optical density and the lowest optical density among the optical densities of the plurality of adjustment patterns is equal to or smaller than the measurement error.

14. The printing apparatus according to claim 12, wherein the optical sensor has at least light source color.

15. The printing apparatus according to claim 13, wherein
a color of the first ink and a color of the print medium are different, and
the color of the second ink is the same as the color of the print medium.

16. The printing apparatus according to claim 14, where the second ink is a white ink or a fluorescent ink.

17. A method of controlling a printing apparatus which includes a print head configured to eject a first ink and a second ink, and which causes the print head to print a plurality of adjustment patterns on a print medium, the adjustment patterns each including a first pattern to be printed with the first ink and a second pattern to be printed on top of the first pattern with the second ink, wherein the plurality of adjustment patterns are different in optical density depending on a shift amount by which print positions of the first pattern and the second pattern are shifted from each other,
the printing apparatus further including an optical sensor configured to measure an optical characteristic of each of the plurality of adjustment patterns, wherein the first ink has an absorption wavelength range detectable with a required S/N ratio in a wavelength band detectable by the optical sensor and the second ink does not have the absorption wavelength range,
the method comprising the step of determining a correction value for ejection timing of the second ink relative to the first ink based on the plurality of adjustment patterns printed by the print head.

18. A non-transitory computer readable storage medium storing a program causing a computer to execute a method of controlling a printing apparatus which includes a print head configured to eject a first ink and a second ink, and which causes the print head to print a plurality of adjustment patterns on a print medium, the adjustment patterns each including a first pattern to be printed with the first ink and a second pattern to be printed on top of the first pattern with the second ink, wherein the plurality of adjustment patterns are different in optical density depending on a shift amount by which print positions of the first pattern and the second pattern are shifted from each other,
the printing apparatus further including an optical sensor configured to measure an optical characteristic of each of the plurality of adjustment patterns, wherein the first ink has an absorption wavelength range detectable with a required S/N ratio in a wavelength band detectable by the optical sensor and the second ink does not have the absorption wavelength range,
the method comprising the step of determining a correction value for ejection timing of the second ink relative to the first ink based on the plurality of adjustment patterns printed by the print head.

19. The printing apparatus according to claim 5, wherein the first pattern is first printed and then the second pattern is printed after a predetermined drying time.

20. The printing apparatus according to claim 19, wherein the predetermined drying time is changed depending on a property of the first ink, a property of the second ink, or a property of the print medium.

21. The printing apparatus according to claim 20, wherein the number of scans for printing the first pattern and the number of scans for printing the second pattern are each increased.

22. The printing apparatus according to claim 21, wherein the number of scans for printing the first pattern and the number of scans for printing the second pattern are each changed depending on a property of the first ink, a property of the second ink, or a property of the print medium.

23. The printing apparatus according to claim 22, wherein a length of the first pattern in a direction orthogonal to the conveyance direction and a length of the second pattern in the direction orthogonal to the conveyance direction are larger than a spot diameter of the optical sensor.

24. The printing apparatus according to claim 22, wherein a length of the first pattern in the conveyance direction and a length of the second pattern in the conveyance direction are larger than a spot diameter of the optical sensor.

25. The printing apparatus according to claim 23, wherein
a measurement error of the optical sensor is determined based on a detection result obtained by printing a plurality of adjustment patterns, each including the first pattern and the second pattern, with the first ink on a print medium, and detecting optical densities of the plurality of adjustment patterns by the optical sensor, and
an optical density difference between the highest optical density and the lowest optical density among the optical densities of the plurality of adjustment patterns is greater than the measurement error.

26. The printing apparatus according to claim 24, wherein
a measurement error of the optical sensor is determined based on a detection result obtained by printing a plurality of adjustment patterns, each including the first pattern and the second pattern, with the second ink on a print medium, and detecting optical densities of the plurality of adjustment patterns by the optical sensor, and
an optical density difference between the highest optical density and the lowest optical density among the optical densities of the plurality of adjustment patterns is equal to or smaller than the measurement error.

27. The printing apparatus according to claim 25, wherein the optical sensor has at least light source color.

28. The printing apparatus according to claim 26, wherein
a color of the first ink and a color of the print medium are different, and
the color of the second ink is the same as the color of the print medium.

29. The printing apparatus according to claim 27, where the second ink is a white ink or a fluorescent ink.
